(19) United States
(12) Patent Application Publication
(10) Pub. No.: US 2008/0099637 A1
(43) Pub. Date: May 1, 2008

(54) Stepless Adjustable Supporting Device

(76) Inventor: Chih-Tang Pai, Fuxing Shiang (TW)

Correspondence Address: HDSL, 4331 STEVENS BATTLE LANE, FAIRFAX, VA, 22033, US

(21) Appl. No.: 11/550,885

(22) Filed: Oct. 19, 2006

(51) Int. Cl. F16M 11/00

(52) U.S. Cl. 248/157

(57) ABSTRACT

A stepless adjustable supporting device includes a base, a lifting arm, a transmission wheel assembly and an elastic module. The present invention employs the lever principle that the product of the load force and the load force arm is equal to the product of the applied force and the applied force arm. Further, with the structure in which a transmission wheel of the transmission wheel assembly is configured to have an eccentric groove, the applied torque generated by the supported article such as displayer with respect to the supporting device is kept to be equal to the load torque generated by the supporting device. In this way, the supporting device can perform a stepless adjustment of various heights while exhibit a supporting effect.

### BACKGROUND OF THE INVENTION

1. Field of the Invention

The present invention relates to a supporting device, and in particular to a stepless adjustable supporting device capable of supporting an article such as displayer and adjusting the supporting length thereof.

2. Description of Prior Art

Generally, the displayer of a current information product is supported by a supporting device and fixed onto a table, ceiling plate, wall or other suitable positions for fixation. The supporting device is generally formed of a fixed structure and thus cannot adjust its length. As a result, the height of the supported displayer is also fixed and thus cannot be adjusted to conform to the different demands of individual users. Therefore, it has poor adaptability and practicability.

Taiwan Patent Publication No. M294002 entitled “Supporting device for a displaying screen” discloses a supporting device, by which the position of the displayer to be mounted can be ascended or descended. The patent document employs a sliding frame of the supporting device to bear the weight of the displayer and the sliding frame can slide relative to a fixed frame of the supporting device. Further, it employs a constant force spring to support the displayer in position. However, the construction and technology disclosed in the above patent document are so complicated. Besides, with only one constant force spring, it is difficult to support the displayer and achieve the stepless adjustment and positioning effect. As a result, the practicability of such product is poor.

In view of the above, the inventor proposes the present invention to overcome the above problems based on his expert experiences and deliberate researches.

### SUMMARY OF THE INVENTION

The present invention is to provide a stepless adjustable supporting device, which employs the lever principle that the product of the load force and the load force arm is equal to the product of the applied force and the applied force arm together with a transmission wheel configured to have an eccentric groove. With the above arrangement, the applied torque is kept to be equal to the load torque, and the height of the supporting device can be adjusted in a stepless manner. Therefore, the whole structure can be further simplified.

The present invention is to provide a stepless adjustable supporting device, which comprises: a base having an accommodating space therein, an opening formed on the top of the accommodating space; a lifting arm comprising a first arm body fixed within the accommodating space and a second arm body slidably lifting on the first arm body, the second arm body extending from the opening; a transmission wheel assembly comprising a transmission wheel pivoted to the base and a driving piece operatively connected with the transmission wheel, the driving piece fixed on the second arm body, the lifting/lowering action of the second arm body driving the transmission wheel to rotate; and an elastic module comprising an elastic element and a swinging rod connected to one end of the elastic element, the other end of the elastic element positioned on the base, wherein the transmission wheel is provided with an eccentric groove thereon, the swinging rod has a swinging portion connected onto the eccentric groove, so that the swinging portion is movable on the eccentric groove when the transmission wheel rotates. With the above arrangement, the applied torque generated by the supported article with respect to the supporting device can be kept equal to the load torque generated by the supporting device, thereby to achieve a stepless adjustment of various lengths and a supporting effect.

### BRIEF DESCRIPTION OF THE DRAWINGS

FIG. 1 is an exploded perspective view of the present invention;

FIG. 2 is an assembled perspective view of the present invention;

FIG. 3 is a cross-sectional perspective view showing a state in which the present invention has not been subjected to a load;

FIG. 4 is a cross-sectional perspective view showing a state in which the height of the present invention is being adjusted;

FIG. 5 is a cross-sectional perspective view showing a state in which the present invention is adjusted to the lowest position; and

FIG. 6 is a partially cross-sectional view showing the transmission wheel assembly of another embodiment of the present invention.

### DETAILED DESCRIPTION OF THE INVENTION

In order to make the Examiner to better understand the characteristics and the technical contents of the present invention, a description relating thereto will be made with reference to the accompanying drawings. However, it should be understood that the drawings are illustrative but not used to limit the scope of the present invention.

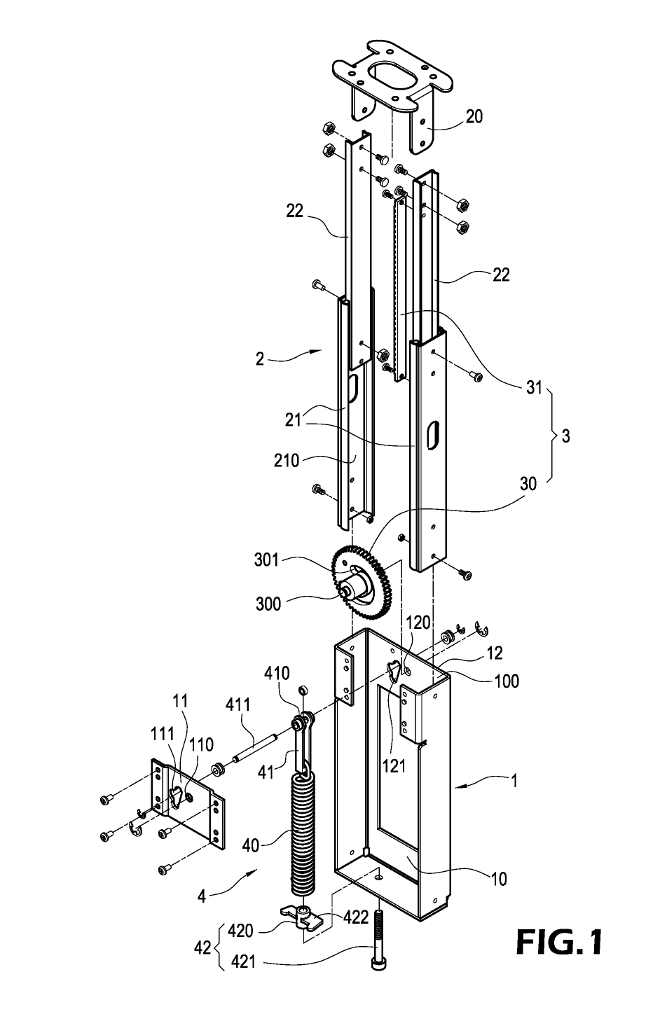

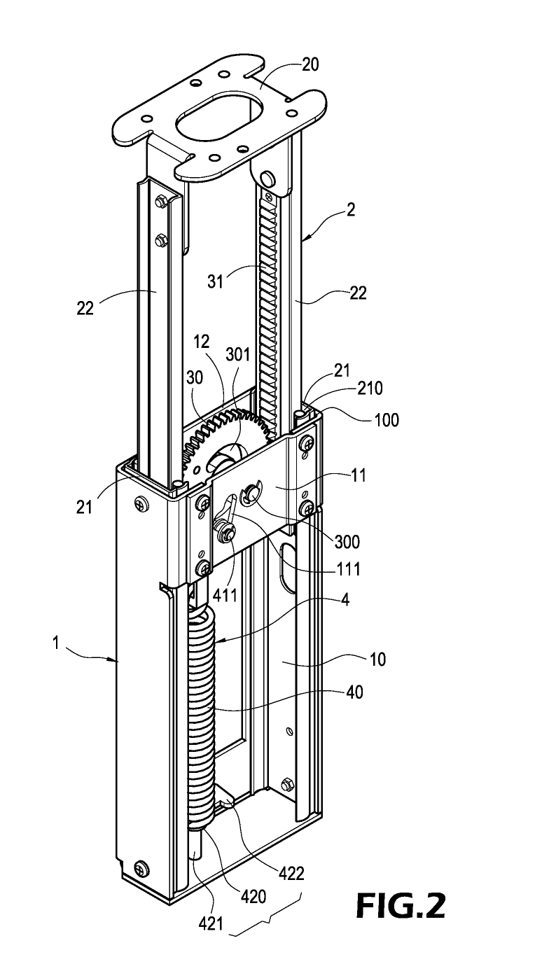

FIGS. 1 and 2 are an exploded perspective view and an assembled perspective view of the present invention, respectively. The present invention provides a stepless adjustable supporting device, which comprises a base 1, a lifting arm 2, a transmission wheel assembly 3 and an elastic module 4.

The base 1 can be mounted on a proper position or device and formed into a rectangular frame. The interior of the base 1 has an accommodating space 10 for accommodating the lifting arm 2, the transmission wheel assembly 3 and the elastic module 4. The accommodating space 10 is formed with an opening 100 on the top of the base 1 to allow the lifting arm 2 within the accommodating space 10 to extend therethrough, thereby to further fix a supported article such as displayer (not shown) to the upper end of the lifting arm 2. A fixing plate 11, 12 is respectively provided at the front and rear ends of the base 1 adjacent to the opening 100. The two fixing plates 11, 12 are provided with pivoting holes 110, 120 and displacing holes 111, 121 to allow the mounting of the transmission wheel 30 of the transmission wheel assembly 3 and a swinging rod 40 of the elastic module 4.

According to the above, the upper end of the lifting arm 2 is provided with a connecting head 20 for connecting with the supported article (such as displayer). The lower end of the lifting arm 2 is accommodated into the base 1 and fixed thereto, as described previously. In the present embodiment of the present invention, the lifting arm 2 has two elongated arm bodies opposing to each other, and comprises a first arm body 21 and a second arm body 22 slidably connected to each other. The first arm body 21 is fixed to the inside of the accommodating space 10 of the base 1. The inside of the first arm body 21 is formed with a vertically oriented sliding trough 210 for slidably disposing on the second arm body 22. With the above arrangement, the second arm body 22 can be lifted and lowered with the guidance of the sliding trough 210.

The transmission wheel assembly 3 comprises a transmission wheel 30 and a driving piece 31 operatively connected to the transmission wheel 30. The center of the transmission wheel 30 is provided with a pivoting shaft 300 protruding outwardly from both surfaces of the wheel 30 so as to be pivoted on the pivoting holes 110, 120 of the two fixing plates 11, 12. Further, the transmission wheel 30 is provided with an eccentric groove 301 thereon. In the present embodiment, the transmission wheel 30 is a gear, and the driving piece is a rack engaged with the gear. The driving piece 31 is fixed to the inside of the second arm body 22 of the lifting arm 2. Therefore, the lifting or lowering operation of the second arm body 22 can also cause the rotation of the transmission wheel 30.

The elastic module 4 comprises an elastic element 40, a swinging rod 41 connected to one end of the elastic element 40, and a fixing piece 42 for positioning the other end of the elastic element 40 onto the base 1. The swinging rod 41 has a swinging portion 410. A shaft rod 411 penetrates through the swinging portion 410 and the eccentric groove 301 of the transmission wheel 30, so that the swinging portion 410 can displace on the eccentric groove 301 via the shaft rod 411. Both ends of the shaft rod 411 penetrate trough the displacing holes 111, 121 of the two fixing plates 11, 12 and thus protrude from the two fixing plates 11, 12 of the base 1. Further, the fixing piece 42 is constituted of a connecting sleeve 420 and a supporting rod 421 connected onto the connecting sleeve 420. The outer periphery of the connecting sleeve 420 is provided with propeller-like side wings 422. The connecting sleeve can be inserted into the other end of the elastic element and screwed into the coils of the spring. The supporting rod 421 penetrates through the bottom surface of the base 1 and then into the connecting sleeve 420. In this way, the above components can be integrally combined with each other. Further, the elastic element 40 may be a tension spring.

Therefore, with the above structure, the stepless adjustable supporting device of the present invention can be achieved.

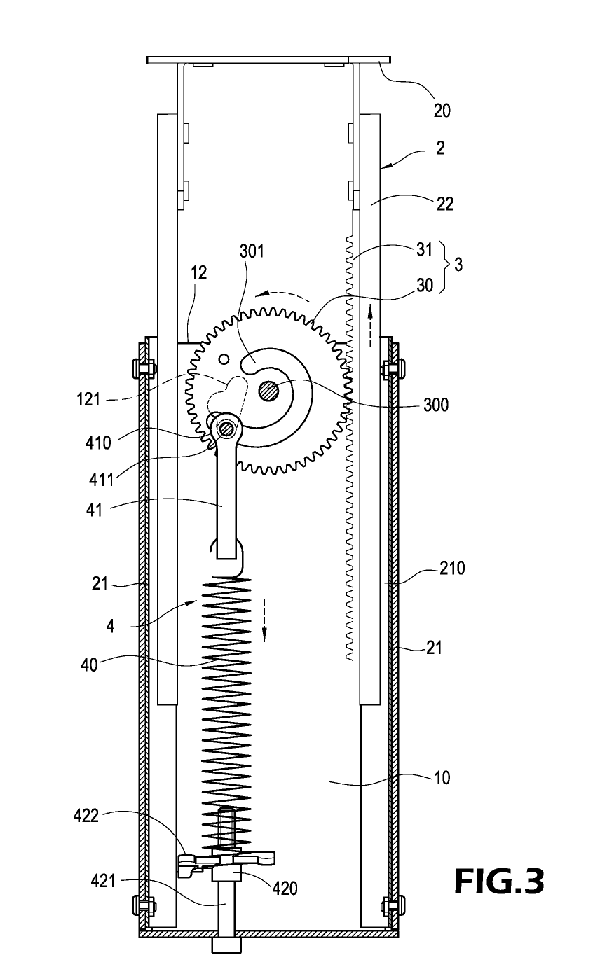

As shown in FIG. 3, when the supporting device has not born a supported article such as displayer, the elastic element 40 is tensioned between the bottom surface of the base 1 and the transmission wheel 30. The elastic force of the elastic element 40 urges the transmission wheel 30 to rotate counterclockwise, thereby to lift the second arm body 22 and maintain the lifting state thereof. In this way, a sufficient force can be generated to bear the supported article (such as displayer) on the connecting head 20.

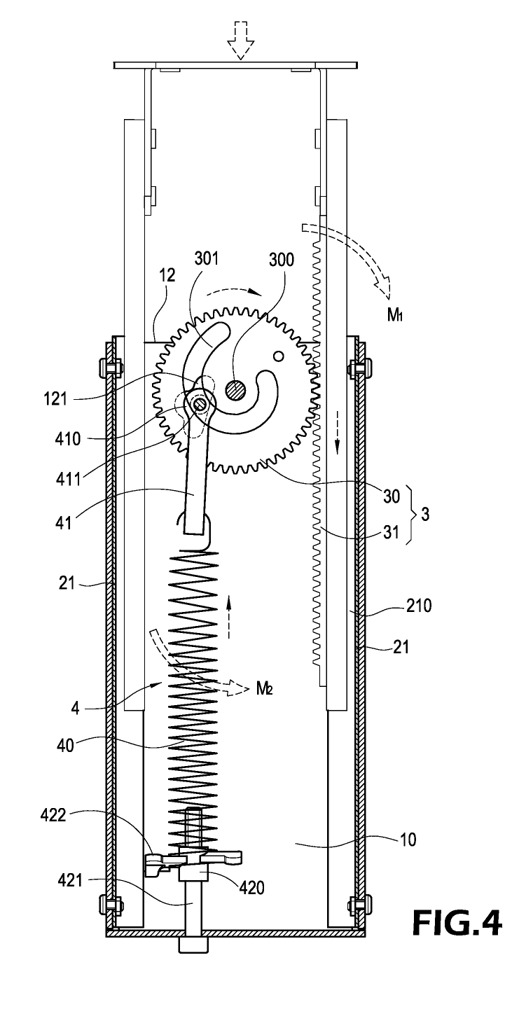

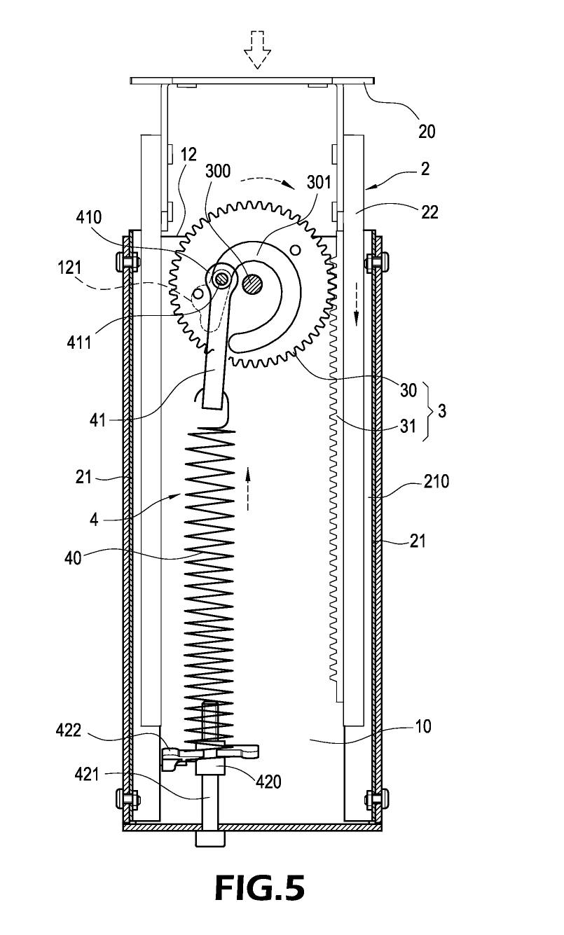

With reference to FIGS. 3 to 5, when a supported article (such as displayer) is mounted on the connecting head 20 of the supporting device, the weight of the supported article will apply a downward pressure to the second arm body 22 (i.e., the applied force), which forms an applied torque M₁ with respect to the center of the transmission wheel 30. The downward tension force generated by the elastic element 40 is the load force, which also forms a load torque M₂ with respect to the center of the transmission wheel 30. In this way, when the applied torque M₁ is equal to the load torque M₂, a balance state can be achieved, thereby to provide a supporting effect. Therefore, the present invention employs the lever principle that the product of the load force and the load force arm is equal to the product of the applied force and the applied force arm, by which the supporting device can provide a supporting effect. Further, with structure of the eccentric groove 301 of the transmission wheel 30, when the second arm body 22 is lowered to adjust its height, such a lowering action will cause the transmission wheel 39 to rotate and thus make the swinging portion 410 of the swinging rod 41 to displace on the eccentric groove 301. At this time, the elastic element 40 is tensioned to shorten the load force arm but enlarge the load force of the load torque M₂. In this way, by maintain the applied torque M₁ to be equal to the load torque M₂, the stepless adjustment of various heights and the supporting effect can be achieved.

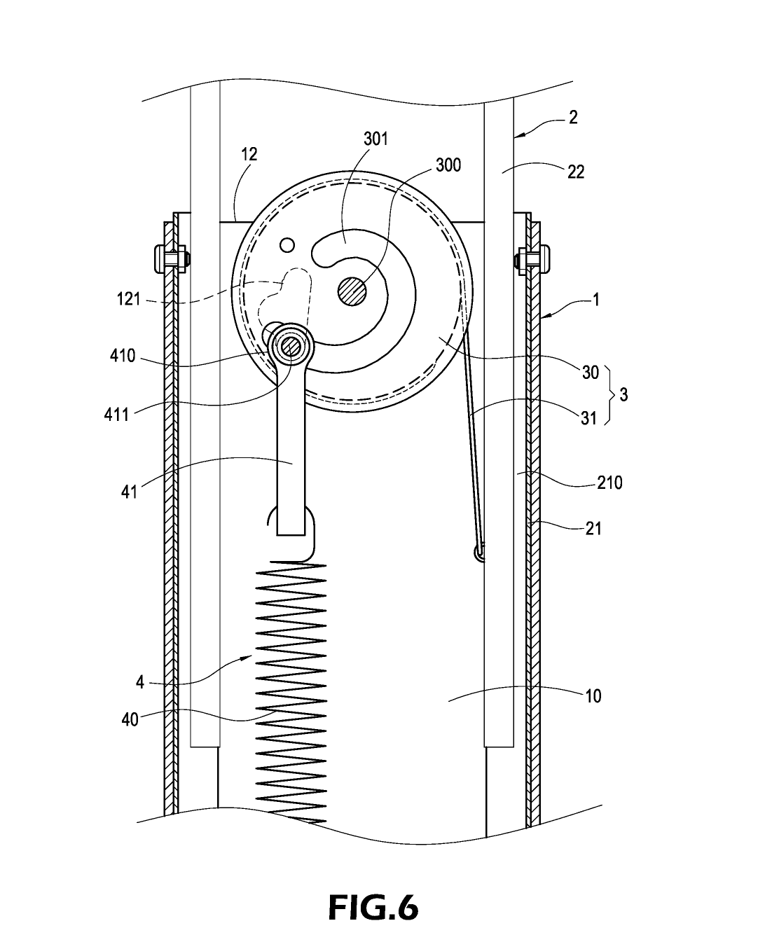

Further, as shown in FIG. 6, the transmission wheel 30 of the transmission wheel assembly can also be a pulley, and the driving piece 31 can be a traction rope. One end of the rope is fixed to the periphery of the pulley and the other end thereof is fixed onto the inside of the second arm body 22 after finishing winding around the periphery of the pulley. With the above arrangement, the lifting/lowering action of the second arm body 22 can also cause the rotation of the transmission wheel 30.

According to the above, the present invention indeed achieves the desired effects and solves the drawbacks of prior art. Further, the present invention involves the novelty and inventive steps and conforms to the requirements for an invention patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A stepless adjustable supporting device, comprising:
a base having an accommodating space therein, an opening formed on the top of the accommodating space;
a lifting arm comprising a first arm body fixed within the accommodating space and a second arm body slidably lifting on the first arm body, the second arm body extending from the opening;
a transmission wheel assembly comprising a transmission wheel pivoted to the base and a driving piece operatively connected with the transmission wheel, the driving piece fixed on the second arm body, a lifting/lowering action of the second arm body driving the transmission wheel to rotate; and
an elastic module comprising an elastic element and a swinging rod connected to one end of the elastic element, the other end of the elastic element positioned on the base,
wherein the transmission wheel is provided with an eccentric groove thereon, the swinging rod has a swinging portion connected onto the eccentric groove, so that the swinging portion is movable on the eccentric groove when the transmission wheel rotates, and
wherein the applied torque generated by the supported article with respect to the supporting device is kept equal to the load torque generated by the supporting device, thereby to achieve a stepless adjustment of various lengths and a supporting effect.

2. The stepless adjustable supporting device according to claim 1, wherein a fixing plate is respectively provided at the front and rear ends of the base adjacent to the opening, so that the transmission wheel is pivoted onto the two fixing plates.

3. The stepless adjustable supporting device according to claim 1, wherein the lifting arm has two elongated arm bodies opposing to each other.

4. The stepless adjustable supporting device according to claim 1, wherein the inside of the first arm body of the lifting arm is formed with a vertically oriented sliding trough for slidably disposing the second arm body into the sliding trough.

5. The stepless adjustable supporting device according to claim 1, wherein the transmission wheel of the transmission wheel assembly is a gear, and the driving piece is a rack engaged with the gear.

6. The stepless adjustable supporting device according to claim 1, wherein the transmission wheel of the transmission wheel assembly is a pulley, and the driving piece is a traction rope, one end of the traction rope is fixed to the periphery of the pulley, and the other end thereof is fixed onto the second arm body after finishing winding around the periphery of the pulley.

7. The stepless adjustable supporting device according to claim 1, wherein the elastic element of the elastic module is a tension spring.

8. The stepless adjustable supporting device according to claim 1, wherein the swinging rod of the elastic module penetrates the swinging portion and the eccentric portion with a shaft rod.

9. The stepless adjustable supporting device according to claim 8, wherein a fixing plate is respectively provided at the front and rear ends of the base adjacent to the opening, the two fixing plates are provided with displacing holes thereon, and both ends of the shaft rod protrude into the displacing holes of the two fixing plates.

10. The stepless adjustable supporting device according to claim 1, further comprising a fixing piece for positioning the other end of the elastic element onto the base.

11. The stepless adjustable supporting device according to claim 10, wherein the fixing piece is constituted of a connecting sleeve and a supporting rod connected onto the connecting sleeve, the outer periphery of the connecting sleeve is provided with propeller-like side wings, the connecting sleeve is inserted into the other end of the elastic element and connected thereto, and the supporting rod penetrates through the base and then into the connecting sleeve to form one body.
